(19) United States
(12) Patent Application Publication
(10) Pub. No.: US 2006/0123481 A1
(43) Pub. Date: Jun. 8, 2006

(54) Method and apparatus for network immunization

(75) Inventors: Atul Bhatnagar, Saratoga, CA (US); Tal Lavian, Sunnyvale, CA (US)

Correspondence Address: JOHN C. GORECKI, ESQ., P.O BOX 553, CARLISLE, MA, 01741, US

(73) Assignee: Nortel Networks Limited, St. Laurent (CA)

(21) Appl. No.: 11/295,920

(22) Filed: Dec. 7, 2005

Related U.S. Application Data
(60) Provisional application No. 60/633,992, filed on Dec. 7, 2004.

(51) Int. Cl. G06F 12/14

(52) U.S. Cl. 726/24

(57) ABSTRACT

Network elements that are configured to perform deep packet inspection may be dynamically updated with patterns associated with malicious code, so that malicious code may be detected and blocked at the network level. As new threats are identified by a security service, new patterns may be created for those threats, and the new patterns may then be passed out onto the network in real time. The real time availability of patterns enables filter rules derived from the patterns to be applied by the network elements so that malicious code may be filtered on the network before it reaches the end users. The filter rules may be derived by security software resident in the network elements or may be generated by a filter generation service configured to generate network element specific filter rules for those network elements that are to be implemented as detection points on the network.

### CROSS REFERENCE TO RELATED APPLICATIONS

This application is related to and claims the benefit of U.S. Provisional Application No. 60/633,992, filed Dec. 7, 2004, entitled “Method and Apparatus For Network Immunization Via Dynamic Assignment of Security Signatures in Deep Packet Inspection Tables,” the content of which is hereby incorporated herein by reference.

### BACKGROUND OF THE INVENTION

1. Field of the Invention

The present invention relates to protection of communication networks and, more particularly, to a method and apparatus for network immunization.

2. Description of the Related Art

Data communication networks may include various routers, switches, bridges, hubs, and other network devices coupled to and configured to pass data to one another. These devices will be referred to herein as “network elements.” Data is communicated through the data communication network by passing protocol data units, such as Internet Protocol (IP) packets, Ethernet frames, data cells, segments, or other logical associations of bits/bytes of data, between the network elements by utilizing one or more communication links between the devices. A particular protocol data unit may be handled by multiple network elements and cross multiple communication links as it travels between its source and its destination over the network.

Malicious code such as computer viruses, Trojan horses, worms, and other malicious code is commonly developed to exploit weaknesses in security measures implemented on computer systems. Malicious code may cause personal information to be collected, may take over control of the infected computer, for example to cause the computer to begin sending out numerous email messages, or may cause numerous other actions to occur. Since malicious code may prevent an user from using their computer and may cause serious security problems, it has become common to implement security software designed to block malicious code from being able to be installed and run on the end personal computers.

There are several ways in which security software has been implemented to date. For example, security software may be implemented on a personal computer, by installing personal firewall software, antivirus software, anti-spyware software, and other types of software designed to protect the personal computer in real time. To enable this software to protect against the latest threats, the malicious code definitions (patterns) need to be updated periodically. Due to the frequency with which new versions of malicious code are developed, it may be necessary to update the malicious code patterns daily or several times per day.

Similarly, security software may be implemented in a server or gateway, either at the ingress to the network or at the egress from the network, so that the traffic being handled by that device is able to be scanned for the presence of malicious code. For example, an email server may be provided with security software that will enable it to scan all incoming or outgoing email traffic and attachments to check for the presence of a computer a virus or other malicious code in the body of the email or in the attachment. If it appears that malicious code may be present, the email or attachment may be blocked by the email server and not transmitted to the intended recipient. In this manner, the flow of malicious code may be blocked by end users or servers associated with the end networks to reduce the ability of the malicious code to carry out the nefarious intent of its creator. Similarly, an ISP email server may scan email sent by its users to detect for the presence of malicious code and block any such email from continuing on the network.

Preventing malicious code at the destination personal computer level is only possible if every destination personal computer is running security software has updated malicious code definitions. Where a computer is not running security software or the definitions in use on the computer are not up-to-date, a new security threat may get past the security software to compromise the security of the computer. Running security software at the server level is generally able to stop particular threats that are carried on traffic that passes that particular server. For example, a security software package on an ingress or egress email server may reduce the amount of viruses transmitted via email. However, security software on an email server will not operate to prevent other types of security threats, such as viruses or other malicious code spread via cookies or in other ways over the Internet. Accordingly, it would be advantageous to provide a more comprehensive solution to prevent the spread of malicious code before it is able to reach the destination servers and destination personal computers.

### SUMMARY OF THE INVENTION

A method and apparatus for immunizing the network is disclosed in which network elements are configured to implement prevention devices on the network, so that threats may be detected and blocked at the network level. According to an embodiment of the invention, the network elements forming the network that are configured to perform deep packet inspection may be dynamically updated with patterns associated with malicious code. The patterns may be implemented as filter rules on network elements so that the malicious code may be filtered out at the network level. As new threats are identified by a security service, new patterns are created for those threats and the new patterns are passed out onto the network in real time, so that the filter rules associated with the patterns may be applied by the network elements. The implementation of network elements as protection devices may prevent the spread of newly detected malicious code before it has a chance to arrive at the end computer device. The patterns may be used to generate filter rules which include layer 4-7 information, as well as layer 2/3 information, so that content filtering may be performed in addition to filtering on characteristics identifiable from the packet header. Optionally, by enabling patterns to extend across multiple protocol data units, it may be possible to prevent malicious code spanning protocol data units from being transmitted on the network.

The network elements implementing the protection devices may include software configured to translate the patterns into filter rules so that, when a pattern is generated, the network elements may generate filter rules to be applied by the network elements to filter for the pattern. Alternatively, the patterns may be sent to a filter generation service configured to receive the patterns identified by the security service and translate the patterns into filter rules for use by the network elements implementing the detection points on the network. The filter rules may then be passed to the network elements for implementation on the network in a manner similar to how other filter rules are passed to these network elements, so that separate security software need not be run on the network elements to enable them to be configured as detection points on the network.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example communication network in which an embodiment of the invention may be implemented;

FIG. 2 is a flow chart illustrating a process of updating patterns on a network to prevent the spread of malicious code according to an embodiment of the invention; and

FIG. 3 is a functional block diagram of a network element configured to implement a protection device according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

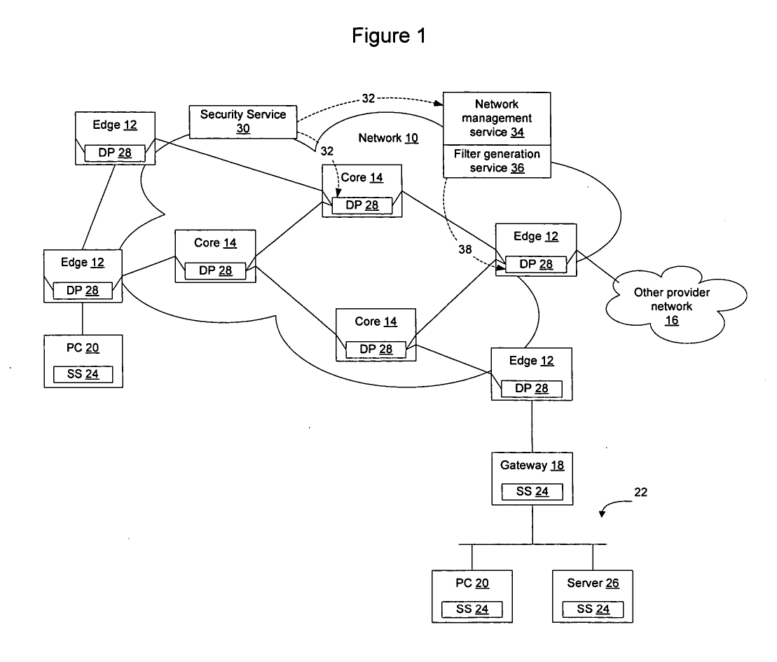

FIG. 1 illustrates an example of a communication network in which an embodiment of the invention may be implemented. In the example shown in FIG. 1, a communication network 10 includes edge network elements 12 interconnected by core network elements 14. Edge network elements 12 are commonly used to enable customers to access the network 10, while core network elements 14 are commonly used to provide high bandwidth transport facilities to transport data across the network 10. The invention is not limited to the particular example network architecture as other network architectures may be used as well.

In the example shown in FIG. 1, edge network elements 12 are illustrated as being able to connect to other edge network elements 12, and to network elements in other provider networks 16. The edge network elements also are configured to connect to customer equipment such as gateways 18, personal computers 20, and other types of commonly used customer and equipment. For example, a particular network subscriber may use one or more gateways 18 to connect a subscriber-run local area network 22 to a provider's network. Other subscribers may connect directly to the provider's network 10, e.g. via a personal computer 20. There are many different ways in which the subscribers may connect to the network 10, and the invention is not limited to the particular manner in which the subscribers elect to connect to the network.

Antivirus software, anti-spyware software, and firewall software (security software 24) may be run in the subscriber's PC 20, or gateway 18, or on a server 26, as is commonly done in conventional networks and computer devices. Implementing security software 24 on these computers provides a layer of security that may help reduce the ability of malicious code to affect the customer equipment. According to an embodiment of the invention, an additional layer of security designed to compliment the security features provided by security software 24 enables malicious code to be blocked at the network level. By enabling the network to help prevent the spread of malicious code, security threats may be blocked before they reach the destination computers or the ingress servers, to thereby provide a more secure computing environment.

According to one embodiment of the invention, one or more of the network elements that are configured to perform deep packet inspection on traffic flowing through the network are configured to implement detection points 28 to block the flow of malicious code on the network. The detection points 28 are configured, according to an embodiment of the invention, to implement filter rules to filter traffic, so that the presence of malicious code on the network may be reduced.

The detection points may be implemented on every network element on the provider network or may be implemented in select network elements. For example, a provider may elect to configure only edge network elements, only core network elements, or a combination of the two types of network elements, as detection points to help stem the flow of malicious code. This decision may be based on the capabilities of the network elements as well as the traffic conditions experienced by the network elements on the network. For example, the core network elements may be implemented as switches without the ability to perform deep packet inspection, or the transmission rate in the core may make it impracticable to perform deep packet inspection in the core network elements. In this instance the provider may elect to implement only the edge network elements as detection points while allowing the core network elements to handle data in a standard manner. The invention is not limited to the manner in which particular network elements are selected to implement the detection points or to a particular arrangement of network elements selected to implement the detection points.

In the example shown in FIG. 1, a security service 30 provides updates 32 as new threats are identified on the network. Currently, security companies such as Symantec™ and MacAfee™ have security agents located around the globe in millions of machines that are designed to detect new viruses and other types of malicious code. When a new threat is identified, the security service 30 will obtain a signature of the threat from the agents (not shown) and generate a pattern that may be used by the network elements 12, 14, to identify the threat. Pattern generation of this sort is currently done by security services, for example, in connection with providing updates to security software 24, and the invention is not limited to a particular manner of generating these types of updates.

Because the network elements 12, 14, on the network 10 may have differently configured forwarding planes, the patterns identified by the security service 30 and sent out as updates 32 may need to be translated into filter rules that are then able to be programmed into the forwarding planes of those network elements. Where the network elements include software configured to translate the patterns into filter rules, the patterns generated by the security service 30 may be sent directly to the network elements configured to implement the detection points. The network elements may then cause the patterns to be translated by the security software on the network elements into filter rules specific to that particular type of network element so that the filter rules may be programmed into the hardware elements responsible for filtering traffic on the network.

Alternatively, where the network elements are not configured to implement software to translate the patterns into filter rules, the patterns generated by the security service may be sent to a network management station 34. The network management station may then pass the patterns to a filter generation service 36 configured to create filter rules specific to the different types of network elements on the network 10. The filter generation service 36, in this alternate embodiment, is configured to translate the pattern received from the security service 30 via update 32 into filter rules 38 that are transmitted to the network elements and used by the network elements 12, 14 to filter traffic on the network. In either embodiment, the filter rules will be installed into the forwarding planes of the network elements configured to act as detection points 28, so that traffic matching the patterns will be removed from the network. By continually updating the detection points 28 in real time as threats are discovered, it is possible to immunize the network against outbreaks of malicious code to reduce the chance that malicious code will reach the customer equipment.

The detection points are implemented on network elements capable of performing deep packet inspection on packets or streams of packets. By performing deep packet inspection, the content of the packet may be scanned as well as the header, so that more detailed filtering may be performed for particular types of threats that are not apparent simply by looking at the fields associated with the packet header.

Deep packet inspection may occur on a particular packet or on a stream of packets. When deep packet inspection is performed on a per-packet basis, the network element will review the content of each packet to determine whether the packet contains known malicious code—i.e. does that particular packet match any filter definition. Deep packet inspection on a stream of packets, by contrast, enables the network element to detect malicious code that is too large to be carried in a single packet. For example, Trojan horses and other types of malicious code may require several packets or even hundreds of packets to be transmitted over the network. By causing the detection points to look for patterns in streams of packets (e.g. a match of a set of filter rules on a set of packets to the same destination), malicious code that spans multiple packets may be stopped at the network level. For example, upon seeing the first several packets that match a particular threat, the detection point may conclude that the flow in which the thread was located should be stopped and may cause the remaining packets from that flow, port, or with similar header information, to be dropped. If a sufficiently large number of packets are dropped, the malicious code may be unable to function when it attempts to install itself in a target computer 14.

By using a security service 30 to distribute security threat updates 32, new security threats may be neutralized quickly once discovered, since information pertinent to the security threat may be passed out to the network elements responsible for handling flows of traffic on the network to enable those network elements to restrict transmission of the new threat on the network. By causing the network elements to use their inherent filtering powers to filter for antivirus as well as other common filtering applications, it is possible to harness the inherent power of the deployed network elements to reduce the ability of the network to transport harmful malicious content.

When a pattern match is found, the traffic may be discarded or, alternatively, additional remedial action may be taken such as to trace the traffic backwards through the network toward the source. Tracing the traffic backwards through the network may enable the source of the traffic to be identified, so that the edge network element connected to the source may cause the port over which the source connects to the network to be shut down. For example, when traffic matching a pattern is identified, the port over which the traffic was received may be used to output a message to the upstream network element to cause the upstream network element to perform inspection for traffic matching the particular pattern. This process may iterate to cause the detection to occur successively closer to the source regardless of whether the traffic includes an accurate source address or other accurate information in the header. Accordingly, the source of the traffic may be identified, and this information may be used to block traffic at the source to prevent future outbreaks on the network.

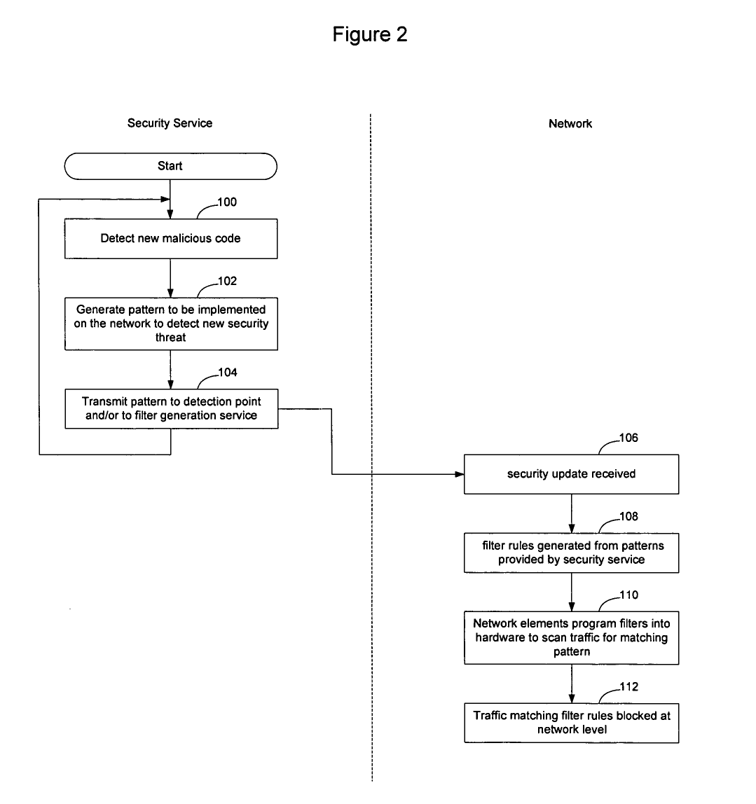

FIG. 2 illustrates a process of immunizing a network according to an embodiment of the invention. In the embodiment shown in FIG. 2, when a, security service detects a new security threat such as a new piece of malicious code that should be blocked on the network, the security service 30 will generate a new pattern to be implemented on the network (102). The new pattern in this instance will be designed to be used to generate filter rules by the network elements implementing the detection points to enable the network elements to filter the threat on the network. The security service 30 will then transmit the pattern to the network elements implementing the detection points or to the network management service, so that filter rules may be generated that may be used to filter the malicious code on the network (104).

When a pattern update 32 is received (106), filter rules will be generated from the patterns provided by the security service (108) and programmed into the network element hardware responsible for implementing filtering functions for the network elements (110). Where the filter rules are generated by the network elements, the patterns may be transmitted by the security service directly to the network elements implementing the detection points. Where the filters are created for the network elements by a filter generation service 36, updates may be passed to the network management service which will cause the filter rules to be generated and passed out to the detection points. Where filter rules are generated remotely from the network elements, for example by the filter generation service 36, the detection points may be implemented on the network elements without requiring the network elements to run security software. This enables the network to implement measures to restrict the ability of malicious code to be disseminated on the network without requiring the network elements to be modified to include the software configured to implement the functions associated with the detection points.

However the pattern definitions/filter rules are transmitted out to the detection points, the network elements program the filter definitions associated with the patterns the hardware elements (i.e. into the network element forwarding plane) so that the network element can be configured to scan the traffic passing through the network element for traffic that matches the new patterns (110). Commonly, filter rules are implemented by hardware in the network element data plane, although the invention is not limited in this manner as other ways of filtering may be used as well. Accordingly, the pattern associated with the malicious code may be implemented as one or more filter rules in the network elements forming the detection points so that traffic matching the pattern associated with the security update may be blocked at the network level (112).

Although a particular method has been described, other methods may be used as well and variations to this method may be implemented to enable the network elements to implement the updates as filter rules. The invention is thus not limited to this particular method as other methods may be used to enable malicious code to be detected and removed from legitimate network traffic.

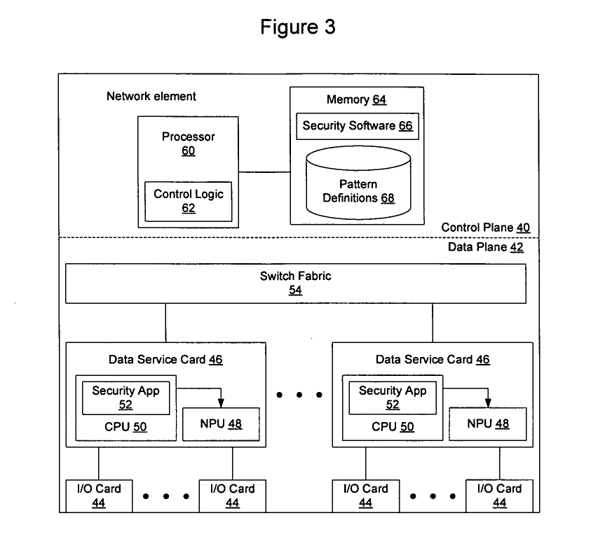

FIG. 3 is a functional block diagram of a network element configured to implement a detection point according to an embodiment of the invention. The invention is not limited to this particular embodiment as network elements may be implemented using many different architectures. Thus, the invention is not limited to an implementation that uses the particular illustrated network element architecture.

In the embodiment shown in FIG. 3, the network element includes a control plane 40 and a data plane 42. The control plane 40 is configured to control operation of the network element and to pass instructions to the data plane 42 as to how the data plane should handle particular packets, classes of packets, and streams of packets.

The data plane 42 is configured to handle packets of data in an efficient manner. As shown in FIG. 3, the data plane, in this embodiment, includes a plurality of I/O cards 44 configured to implement the physical ports so that the network element may be connected to optical, metallic, or wireless links on the communication network. The I/O cards 44 may also include preprocessing circuitry configured, for example, to reassemble packets from frames or other types of protocol data units being used to transport the data across the physical media connected to the ports.

Data received by an I/O card is passed to a data service card 46 where it is filtered to cause data matching particular filter rules to be dropped or otherwise identified for special processing in the network element. Filtering is commonly performed in network elements and enables a network element to identify particular packets of data. Generally, a Network Processing Unit (NPU) 48 is used to implement the filter rules, so that the filters may be applied to the packets rapidly using hardware rather than software based filters.

The data service card 46 also includes a processor 50 configured to implement applications such as security application 52. The processor 50 is also configured to program new filter rules into the NPU 48. When new filter rules are received by the network element, such as filter rules generated as a result of an update from the security service 30, the filter rules may be passed to the CPU 50 on the data service card 46 to be programmed into the NPU 48 responsible for performing filtering of traffic received by the network element. The CPU in this instance is also running on the data service card 46 and contains an interface to the NPU 48 that will enable it to program the microcode into the NPU so that the NPU will perform packet filtering using the updated filter definitions. By updating the filtering rules in a network element capable of filtering on layers 4-7, content based filtering using deep packet inspection may be performed and used to detect and remove malicious code on the network.

Packets not filtered by the data service card 46 are passed to a switch fabric 54 that is configured to switch packets between data service cards on the data plane 42 of the network element. Packets returning from the switch fabric will be sent to one of the data service cards 46 (either the same one or a different one) and then passed out onto the network via one of the I/O cards 34. Additional filtering may be performed on the egress path as the packets pass from the switch fabric 54 to the I/O cards 34 as well and the invention is not limited to an embodiment that performs ingress filtering.

The network element also includes a control plane 40 configured to control operation of the manner in which the data plane is operating. In the embodiment shown in FIG. 3, the control plane includes a processor 60 configured to implement control logic 62 that will enable the network element to implement a detection point on the network 10. Specifically, in the embodiment shown in FIG. 3, the processor 60 is connected to a memory 64 containing security software 66 and pattern definitions 68. When a pattern update 32 is received from the security service 30, the pattern is stored in the pattern definition database 68 and passed to the security software 66. The security software 66 is configured to generate one or more filters based on the pattern that will be able to be used by the NPU 48 to filter traffic on the network. The filter definitions will be passed to the security application 52 on the CPU 50 that uses the filter definitions to program the NPU to filter traffic according to the pattern received from the security service.

In an alternative embodiment, where the updates containing patterns are passed to the network management service, and filter definitions are passed from the filter generation service to the network elements, the security software 66 and/or security software 52, may be configured to receive the filter definitions and cause the filter definitions to be implemented in the network element by causing the filter definitions to be programmed into the NPU 48. The invention is not limited to a particular manner in which the control plane and data plane divide up the processes required to enable the network element to implement the detection point. Specifically, there are many different ways in which software components may be configured to enable the network element to implement filter rules that will allow the network element to filter malicious code from traffic being handled by the network element. The invention is therefore not limited to the particular embodiment shown in FIG. 3.

The functions described above may be implemented as a set of program instructions that are stored in a computer readable memory within a network element and executed on one or more processors within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of immunizing a communication network containing a plurality of network elements configured to perform deep packet inspection, the method comprising the steps of:
receiving a pattern associated with an instance of malicious code;
converting the pattern into a filter rule; and
causing the filter rule to be programmed into a hardware filtering platform associated with at least one of the network elements that is configured to perform deep packet inspection to enable the malicious code matching the pattern to be filtered from the network.

2. The method of claim 1, wherein the malicious code is a computer virus.

3. The method of claim 1, wherein the steps of receiving the pattern and converting the pattern into a filter rule are not performed by the at least one of the network elements.

4. The method of claim 3, wherein the step of causing the filter rule to be programmed comprises transmitting the filter rule to the at least one of the network elements.

5. The method of claim 1, wherein the step of receiving the pattern is performed by a network management service and wherein the step of converting the pattern into the filter rule comprises transmitting the pattern to a filter generation service, said filter generation service being configured to generate network element specific filter rules for use by network elements with different forwarding plane architectures.

6. The method of claim 1, wherein the steps of receiving the pattern and converting the pattern into a filter rule are performed by the at least one of the network elements, and wherein the step of causing the filter rule to be programmed comprises programming the filter rule into the hardware filtering platform.

7. A network element, comprising:
a data plane containing hardware configured to perform deep packet inspection on data received over an interface to a communication network in connection with forwarding the data on the communication network; and
a control plane configured to control operation of the data plane,
wherein the network element contains control logic configured to program filter rules associated with malicious code into the hardware configured to perform deep packet inspection to enable the malicious code to be filtered from the network.

8. The network element of claim 7, wherein the hardware is a network processing unit configured to identify protocol data units having characteristics that match at least one of the filter rules that have been programmed into the hardware.

9. The network element of claim 8, further comprising a processor associated with the data plane, said processor containing the control logic configured to program the filter rules into the network processing unit.

10. The network element of claim 7, wherein the control plane comprises a processor containing second control logic configured to receive at least one malicious code pattern update and generate the filter rules associated with the malicious code from the malicious code pattern update.

11. The network element of claim 7, wherein the control plane comprises a processor containing control logic configured to receive the filter rules associated with the malicious code.

12. A network element, comprising:
means for filtering data by performing deep packet inspection on traffic flowing through the network element; and
means for programming a filter rule into the means for filtering, to cause the filter rule to be applied to the traffic flowing through the network element, said filter rule being associated with a pattern identified as comprising at least a part of a malicious code to be filtered from the traffic flowing through the network element.

13. The network element of claim 12, further comprising means for receiving the filter rule from at least one of a filter generation service and a network management service.

14. The network element of claim 12, further comprising means for receiving a pattern associated with the malicious code, and means for generating the filter rule from the pattern.

15. The network element of claim 12, wherein the malicious code comprises at least one of a Trojan horse, computer virus, and spyware.
